(19) United States
(12) Patent Application Publication
(10) Pub. No.: US 2021/0304906 A1
(43) Pub. Date: Sep. 30, 2021

(54) ADDITION INTO THE FUEL MIXTURE OF NUCLEAR FUEL FOR NUCLEAR REACTORS

(71) Applicant: West Reality, S.R.O., Kosice (SK)

(72) Inventor: Peter Rafay, Kosice (SK)

(73) Assignee: West Reality, S.R.O., Kosice (SK)

(21) Appl. No.: 17/261,856

(22) PCT Filed: Dec. 3, 2018
(86) PCT No.: PCT/SK2018/000010

§ 371 Date: Jan. 20, 2021

(30) Foreign Application Priority Data
Jul. 24, 2018 (SK) PP67-2018

(51) Int. Cl. G21C 3/62; G21C 3/58; G21D 1/00

(52) U.S. Cl. CPC G21C 3/62; G21D 1/00; G21C 3/58

(57) ABSTRACT

In one form, during the production of electrical energy from a stable uranium isotope by means of a fission chain reaction, extra neutrons are formed that can be used, in addition to electricity production, to also convert certain elements to other elements, specifically of some selected stable isotopes of particular elements to stable isotopes of other elements.

Neutron sources are used in the production of electrical energy in nuclear reactors, which are currently considered to be nuclear waste (they are absorbed in control rods in reactors and considered to be undesirable parts, that could start an uncontrolled fission reaction), or they are used to produce militarily sensitive fissionable plutonium, the commercial use of which is not allowed at present due to possible military abuse.

### FIELD

The invention is concerned with the admixture for the mixture of nuclear fuel assigned for nuclear reactors using stable isotopes of cadmium and a stable isotope of mercury, followed by a nuclear transformation of these stable natural isotopes by neutrons generated during the fission chain reaction of the original component of the fuel mixture of nuclear uranium fuel used in a nuclear reactor.

### BACKGROUND

In case of the nuclear uranium type reactors the fuel mixture of the nuclear fuel used until now consists of the uranium element, from two naturally occurring stable isotopes of uranium which is mined in sites containing uranium deposits:

₉₂²³⁵U+₉₂²³⁸U

An isotope is an element with the same proton number=the same number of protons in the nucleus of the element (in the case of uranium this number is 92 protons in the nucleus) and different number of neutrons in the nucleus (for ₉₂²³⁵U isotope the number of neutrons in the nucleus equals to 143 and for the ₉₂²³⁸U isotope the number of neutrons in the nucleus is the 146). The sum of protons and neutrons in the nucleus gives the number of nucleons in the nucleus (for the ₉₂²³⁵U isotope is their number 235 and for the ₉₂²³⁸U isotope is their number 238). Under natural conditions, uranium isotopes are present as follows: ₉₂²³⁵U—0.72% and ₉₂²³⁸U—99.274% of total natural uranium. After neutron irradiation these two isotopes will undergo two completely different types of reactions in the nuclear reactor.
1) A fission chain reaction caused by a so-called fissionable uranium isotope specifically by ₉₂²³⁵U which will cause the fission chain reaction after the neutron irradiation under equation [1]:

₉₂²³⁵U+₀¹n→₃₆⁹³Kr+₅₆¹⁴⁰Ba+3₀¹n+160.5 MeV (kinetic energy of the reaction fragments) Equation [1]:

This means that this isotope mixture enriched to 2.5-3% and sometimes up to 5%, is exposed to the influence of neutrons at the beginning of the process, which will start the fission chain reaction and cause the splitting of the nucleus of this isotope into two approximately equal-sized nuclei while two elements originate (in this case two isotopes of krypton and barium that are unstable and they decay further according to known equations and we call them radioactive waste).

In this decay 3 neutrons are generated on average and heat of 160.5 MeV is released, which will be used to heat water in the primary circuit of the nuclear reactor, through the heat exchanger it will further heat the water in the secondary circuit of the nuclear reactor and transform it into steam which rotates the turbine of the steam generator and subsequently generates electricity. From the three neutrons generated, one will be used to repeat the fission chain reaction, and that is why we call it a chain reaction, as this one neutron reacts with the fissionable isotope ₉₂²³⁵U and it splits further and the other two neutrons have to be contained in order for the reaction to remain controlled. These two neutrons are captured by another uranium isotope (specifically by ₉₂²³⁸U isotope that is not fissionable, causing a moderating reaction (which can also be called a multiplier or breeder reaction, as there are additional isotopes multiplied and bred in it, and new fissionable isotopes formed).
2) The moderating (multiplying or breeder) nuclear reaction is such that the remaining two neutrons originating from the fission reaction are captured by an isotope of uranium, specifically ₉₂²³⁸U, which absorbs these neutrons into its nucleus according to the reaction described in the equation [2]. It does not cause a fission chain reaction anymore, however it is changed into a new uranium isotope ₉₂²³⁹U which is unstable and will emit an electron (beta minus radiation) and will be converted to a neptunium isotope, specifically ₉₃²³⁹Np which is also unstable and it will emit an additional electron (beta minus radiation), which will convert to a fairly stable plutonium isotope, specifically ₉₄²³⁹Pu, which is also fissionable and it is also used to generate electricity (as it is also a source of neutrons) and for military use, specifically for the manufacturing of a nuclear plutonium bomb. Plutonium is also very toxic and it is not for sale.

₉₂²³⁸U+₀¹n→₉₂²³⁹U→₉₃²³⁹Np+₋₁⁰e→₉₄²³⁹Pu+₋₁⁰e The equation [2]:

Deficiencies of the prior technique:
1) Possibility of misuse of plutonium for military purposes
2) High toxicity of the created plutonium
3) Impossibility of commercial use of plutonium
4) Insufficient evaluation of generated neutrons, which is mostly considered to be waste

5) Reduced economic efficiency of electricity generation

### DETAILED DESCRIPTION

The deficiencies and disadvantages mentioned above are essentially eliminated through the proposed addition into the fuel mixture of the nuclear fuel into nuclear reactors according to the invention, the essence of which is that the admixture is added into or the nuclear fuel and consists of stable cadmium isotopes, specifically of ₄₈¹⁰⁶Cd, ₄₈¹⁰⁸Cd isotopes, where transformation of these natural stable isotopes of cadmium into stable silver isotopes occurs, specifically ₄₇¹⁰⁷Ag, ₄₇¹⁰⁹Ag by neutrons resulting from the fission chain reaction of the original nuclear uranium fuel component consisting of the uranium isotope ₉₂²³⁵U and they partially replace the creation of plutonium for military use, specifically of the ₉₄²³⁹Pu isotope, while the created stable silver isotopes can be commercially used.

### And/Or

The admixture into the fuel mixture of the nuclear fuel for nuclear reactors, consisting of a stable isotope of mercury, specifically of the stable natural ₈₀¹⁹⁶Hg isotope, where there is a nuclear transformation to a stable gold isotope, specifically ₇₉¹⁹⁷Au, by neutrons originating during the fission chain reaction of the original component of the nuclear uranium fuel from the uranium isotope ₉₂²³⁵U and they partially replace the formation of plutonium for military use, particularly ₉₄²³⁹Pu isotope, whereby the stable gold isotope produced can be commercially used.

At present, most neutrons are captured in the reactor control rods, where they are absorbed, alternatively a fraction f the neutrons is used to produce the plutonium isotope, ₉₄²³⁹Pu isotope, which can be used again to produce electricity, similar to the uranium isotope ₉₂²³⁵U, and also for the production of an atomic bomb, and this is a process undesirable in the peaceful use of nuclear power. We can say that in addition to producing the plutonium isotope, most neutrons are not used and are without economic effect, and the sale of plutonium is not possible due to possible military use.

The advantage of the invention consists in the fact that the neutrons generated during the fission nuclear reaction from the uranium isotope ₉₂²³⁵U will be utilized more efficiently from both a technical and economic standpoint (according equation [1]).

### Proposal of the Fuel Mixture for Use in a Nuclear Fission Reactor

According to the technical features of the invention the admixture added into the fuel mixture of the uranium nuclear fuel used at present, which consists of uranium isotopes, particularly ₉₂²³⁵U+₉₂²³⁸U, found in a naturally harvested uranium ore, with the natural occurrence of isotopes being ₉₂²³⁵U—0.72% and ₉₂²³⁸U—99.274% from the total natural uranium, with this ore being enriched to a higher concentration of the fissile isotope of uranium ₉₂²³⁵U to a percentage value of 2.5% to 3%, and sometimes even to 5% of the total uranium mixture.

The advantage of the invention is that the neutrons generated during the fission nuclear reaction from the uranium isotope ₉₂²³⁵U (under the equation [1]) are better utilized technically and economically.

Here the possibility of usage is caused by the fact that neutron sources generated during the production of electricity in a nuclear reactor are not being used sufficiently (except for the production of fissionable ₉₄²³⁹Pu for military use).

The invention offers a new composition of the mixture of nuclear fuel:

The current mixture of nuclear fuel+admixture consisting of:
Two natural cadmium isotopes, specifically: ₄₈¹⁰⁶Cd and ₄₈¹⁰⁸Cd that are converted after the addition of one neutron into unstable cadmium isotopes: ₄₈¹⁰⁷Cd and ₄₈¹⁰⁹Cd. These two unstable isotopes are changed in a nuclear transformation after an electron gets emitted (beta minus radiations) into two stable isotopes of silver ₄₇¹⁰⁷Ag and ₄₇¹⁰⁹Ag under the equation [3]:

₄₈¹⁰⁶Cd+₀¹n→₄₈¹⁰⁷Cd

₄₈¹⁰⁸Cd++₀¹n→₄₈¹⁰⁹Cd

₄₈¹⁰⁷Cd→₄₇¹⁰⁷Ag +₋₁⁰e with a half-life of 6.5 hours

₄₈¹⁰⁹Cd→₄₇¹⁰⁹Ag +₋₁⁰e with a half-life of 461 days The Equation [3]:
From a stable natural mercury isotope, specifically ₈₀¹⁹⁶Hg, which gets converted after the addition of one neutron into an unstable mercury isotope ₈₀¹⁹⁷Hg, which then gets converted in a nuclear transformation after the irradiation of an electron (beta minus radiation) into a stable gold isotope ₇₉¹⁹⁷Au. These reactions are carried out according to the equation [4]:

₈₀¹⁹⁶Hg+₀¹n→₈₀¹⁹⁷Hg

₈₀¹⁹⁷Hg→₇₉¹⁹⁷Ag+β⁻ The Equation [4]:

### DESCRIPTION OF MINIMUM ONE EXAMPLE OF A PRACTICAL IMPLICATION OF THE INVENTION

### Example No. 1

Cadmium isotopes are added to the currently used mixture of the uranium nuclear fuel used in nuclear reactors, specifically ₄₈¹⁰⁶Cd and ₄₈¹⁰⁸Cd, which are converted to two unstable cadmium isotopes ₄₈¹⁰⁷Cd and ₄₈¹⁰⁹Cd after the addition of two neutrons which are generated as a surplus during the fission reaction under the equation [1]. These two unstable cadmium isotopes are transformed into two stable silver isotopes ₄₇¹⁰⁷Ag and ₄₇¹⁰⁹Ag during the nuclear transformation, after electron irradiation (beta minus radiation) as described by the equation [3]:

₄₈¹⁰⁶Cd+₀¹n→₄₈¹⁰⁷Cd

₄₈¹⁰⁸Cd++₀¹n→₄₈¹⁰⁹Cd

₄₈¹⁰⁷Cd→₄₇¹⁰⁷Ag +₋₁⁰e with a half-life of 6.5 hours

₄₈¹⁰⁹Cd→₄₇¹⁰⁹Ag +₋₁⁰e with a half-life of 461 days The Equation [3]:

Thus, the stable isotopes of silver, that are economically more valuable than the original cadmium isotopes, are generated in the nuclear reactor.

### Example No. 2

Similarly to the currently used mixture of nuclear uranium fuel for nuclear reactors a mercury isotope is added, specifically ₈₀¹⁹⁶Hg, which is converted into an unstable mercury isotope ₈₀¹⁹⁷Hg after the addition of one neutron, and during the nuclear transformation this unstable mercury isotope will be transformed into an stable gold isotope ₇₉¹⁹⁷Au, after an electron has been emitted (beta minus radiation). These reactions are carried out according to equation [4 ]:

₈₀¹⁹⁶Hg+₀¹n→₈₀¹⁹⁷Hg

₈₀¹⁹⁷Hg→₇₉¹⁹⁷Ag+β⁻ The Equation [4]:

This way a stable gold isotope is generated in the nuclear reactor, and it is economically more valuable than the original mercury isotope.

Practically, this invention can be used in all active atomic reactors, the installed performance of which represents an equivalent of 370 units of 1 GW reactors. By this invention it would be possible to produce an additional 1480 t of gold annually, which is only by the annual mining of natural mercury in amount of 3600 tons, from which 5 tonnes of ₈₀¹⁹⁶Hg isotope can be obtained. From this isotope, through the action of neutrons, it is able to produce approximately the same amount of the stable gold isotope ₇₉¹⁹⁷Au.

1-10. (canceled)

11. A uranium nuclear fuel mixture, comprising an admixture including one or more of cadmium isotopes ₄₈¹⁰⁶Cd and ₄₈¹⁰⁸Cd and mercury isotope ₈₀¹⁹⁶Hg.

12. A method, comprising adding cadmium isotopes ₄₈¹⁰⁶Cd and ₄₈¹⁰⁸Cd as an admixture to a uranium nuclear fuel mixture in one or more nuclear reactors to obtain silver isotopes ₄₇¹⁰⁷Ag and ₇₉¹⁰⁹Ag.

13. The method of claim 12, wherein the one or more nuclear reactors have a power of 1 GW.

14. A method, comprising adding a mercury isotope ₈₀¹⁹⁶Hg as an admixture to a uranium nuclear fuel mixture in one or more nuclear reactors to obtain a gold isotope ₇₉¹⁹⁷Au.

15. The method of claim 14, wherein the one or more nuclear reactors have a power of 1 GW.
